(19) United States
(12) Patent Application Publication
(10) Pub. No.: US 2008/0154574 A1
(43) Pub. Date: Jun. 26, 2008

(54) APPLICATION EMULATION ON A NON-PRODUCTION COMPUTER SYSTEM

(76) Inventors: JODI A. BUECHLER, Tucson, AZ (US); Harold Steven Huber, Tucson, AZ (US); David C. Reed, Tucson, AZ (US); Max D. Smith, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/614,394

(22) Filed: Dec. 21, 2006

(51) Int. Cl. G06F 9/445

(52) U.S. Cl. 703/26

(57) ABSTRACT

A method, system and computer-readable medium for emulating an application in a non-production computer system are presented. In a preferred embodiment, the method includes the steps of: receiving a first input that selects an application from all applications on a production computer system; receiving a second input that selects specific control files and data files that are to be utilized in an emulated version of a selected application on a non-production computer system; migrating a copy of instructions file from the selected application from the production computer system to the non-production computer system; migrating a copy of the specific control files and data files from the production computer system to the non-production computer system; and executing the copy of instructions files, while using the copy of the specific control files and data files, in the non-production computer system.

### BACKGROUND OF THE INVENTION

1. Technical Field

The present invention relates in general to the field of computers, and more particularly to software programs. Still more particularly, the present invention relates to emulating an application, which is running on a production computer system, in a non-production computer system, thus permitting testing of the application without disrupting the production computer system.

2. Description of the Related Art

While components of a software application can be categorized in many ways, a useful concept, when describing the present invention, is to consider an application as being composed of an instructions file, data files and configuration files. As the name implies, an instructions file contains lines of code (instructions) that “tell” (instruct) a computer how to manipulate data in the data files. Examples of such instructions are “add,” “subtract,” “compare,” etc. By utilizing many such instructions in a logical manner, a computer can perform complex operations, including database management, word processing, graphic design, telecommunication, etc.

While instructions tell a computer how to function (i.e., how to process data in the data files), a configuration file tells the instructions what parameters to use. Examples of such parameters include file names used for various application components, page lengths, fonts used by the application, what operating system is to be used, etc. There are literally hundreds of parameters that are described and controlled by the entries in the configuration files.

Different operating systems name and utilize their configuration files differently. For example, Unix® user applications often create a configuration file in a home directory of the user upon startup. Unix® server processes often use configuration files in an installation directory, a root directory, or a location defined by a system administrator. Furthermore, some Unix® configuration files run a set of commands upon startup, such as commands to change directories, run certain programs, create or delete certain files, etc., in order to customize the Unix® session.

Microsoft® Windows® operating systems typically use a Windows® registry to store configuration information. The Windows® registry is a database that contains information and settings for hardware, software, users, and preferences of a computer that is running Window®. For example, whenever a user makes changes to “Control Panel” settings, or file associations, system policies, or installed software, the changes are reflected and stored in the registry.

IBM®'s OS/2® operating system uses a binary formatted registry file named INI (for “initialization”). Unlike the Window® registry, the OS/2® profile (registry) contains a list of key-value pairs, which describe string, data and Boolean operative properties.

Although technically different in some ways, for the purposes of the presently described invention, the terms “registry,” “registry file,” “configuration file,” and “profile” are used interchangeably to describe a configuration file.

At times, a software developer may desire to test some or all of an application by simulating changes to a configuration file, data changes, performance of an upgrade/maintenance on the application, etc. When such testing is performed in a production computer system that is “on line” with an enterprise's activities, problems are likely to occur. At a minimum, such testing changes files, registers, buffers, environmental settings, etc., when compared to running the application without the testing changes. In a worst case, such testing can cause the entire system to crash.

### SUMMARY OF THE INVENTION

To address the problem described above, the present invention provides for a method, system and computer-readable medium for emulating an application in a non-production computer system. In a preferred embodiment, the method includes the steps of: receiving a first input that selects an application from all applications on a production computer system; receiving a second input that selects specific control files and data files that are to be utilized in an emulated version of a selected application on a non-production computer system; migrating a copy of instructions file from the selected application from the production computer system to the non-production computer system; migrating a copy of the specific control files and data files from the production computer system to the non-production computer system; and executing the copy of instructions files, while using the copy of the specific control files and data files, in the non-production computer system.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1A depicts an application being migrated to and emulated on a non-production computer system;

FIG. 1B illustrates additional detail of files associated with the application shown in FIG. 1A;

FIGS. 1C-D depict Graphical User Interfaces (GUIs) that may be presented to a user to select an application, and particular supporting files for that application, to be emulated on the non-production computer system;

FIG. 2 is a flow-chart of exemplary steps taken to migrate and emulate an application on a non-production computer system; and

FIG. 3 illustrates an exemplary architecture for a production, non-production, and software deploying server in which the present invention may be utilized.

### DETAILED DESCRIPTION OF THE PREFERRED EMBODIMENT

The present invention allows a software developer to simulate changes made to an application (e.g., system hardware configuration changes, date changes, software maintenance, updates to instruction code, etc.), and to test those changes, without affecting production activities.

In a preferred embodiment of the present invention, an inventory of all applications on the system is made. Once the inventory is completed, a window is created, which displays all of the applications installed on a production computer system. From this window, the software developer is able to choose a specific application for testing in a non-production computer system. (A production computer system is defined as a computer system that is “on line,” and thus is executing an application in real-time in accordance with a commercial utilization that produces a product or service for an enterprise. A non-production computer system is defined as a computer system that is “off line,” and thus does not produce a product or service of the enterprise when executing an application.) Once an application is selected for emulation, the software developer is presented with multiple data files and control files that are used by the selected application. The software developer selects specific selected data files and/or control files, which are then used when emulating the selected application in the non-production computer system. A copy of the instruction, data and control files of the application are then migrated to the non-production computer. Preferably, the copy of the instructions file is pre-migrated, and the copy of the data/control files are transferred at a specific point in time using a fast replication service. Once the application copy is migrated to the non-production computer, the copied instruction, data and/or control files can be altered for testing purposes. By making such changes, subsequent execution results from the unadulterated version of the application, running on the production computer system, can be compared with subsequent execution results from the adulterated version of the application, which is running on the non-production computer system, thus giving the software developer the ability to evaluate the effects of alterations to the application.

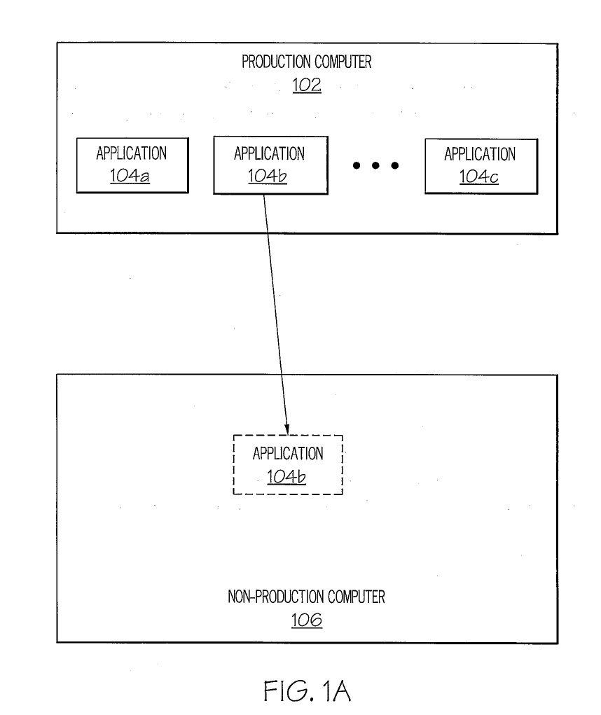

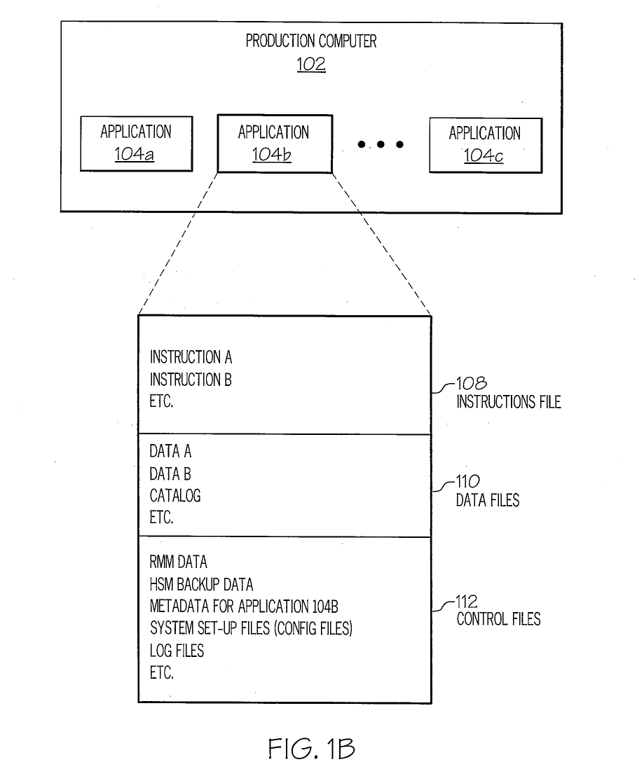

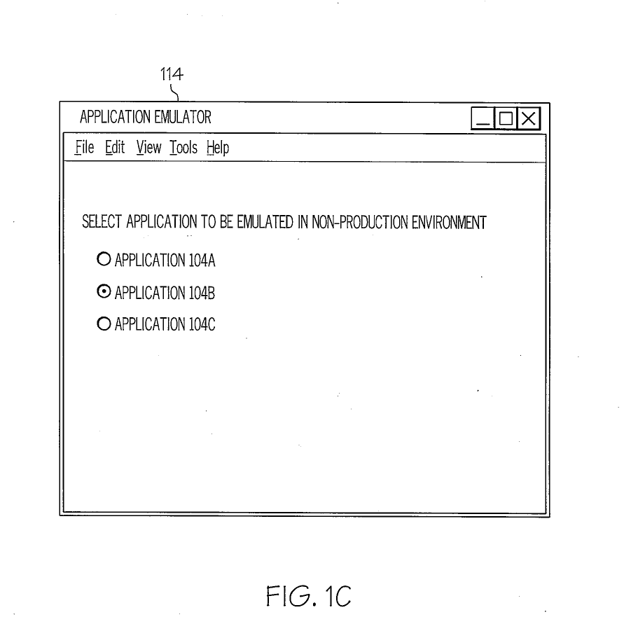

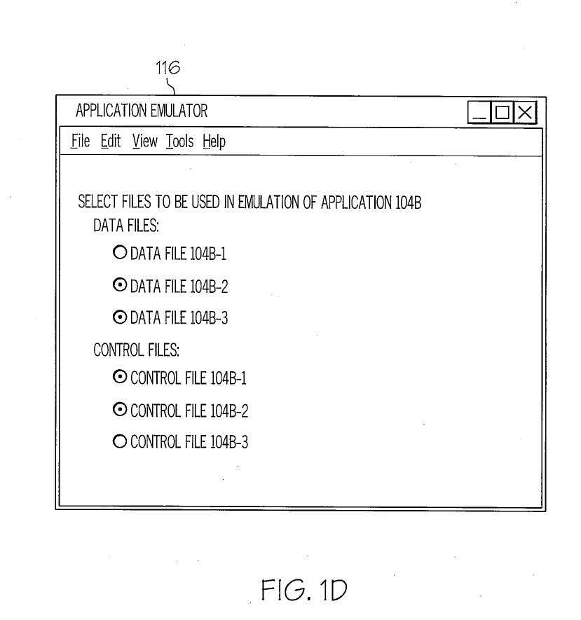

With reference now to the figures, and in particular to FIG. 1A, an exemplary environment in which the present invention can be performed is presented. A production computer 102 is shown running (or at least containing) multiple applications 104a-c. In order to test one of the applications 104, without impacting on the rest of the environment of production computer 102 (including the other applications 104a and 104c), a copy of application 104b is migrated to a non-production computer 106. Note that application 104b continues to execute normally and without any interruption in production computer 102 while being migrated to non-production computer 106.

Referring now to FIG. 1B, additional detail is shown for the structure of application 104b. Application 104b includes an instructions file 108, data files 110, and control files 112. Instructions file 108 includes the instructions (e.g., lines of code, object code methods/classes, etc.) that are used by application 104b. Data files 110 include all data (e.g., pointers to real or virtual memory addresses in which data is stored, object code attributes, etc.) available to the instructions in instructions file 108. Control files 112 include files which configure the execution of the instructions in instructions file 108. Exemplary control files include Removable Media Manager (RMM) data (for managing volumes stored on tape, floppy drives, keychain drives, etc.); Hierarchical Storage Manager (HSM) backup data (which automates the movement of seldom used files to and from near line storage); metadata (which describes the application itself, including the application's version, required operating system, memory requirements, etc.); configuration files (described above); log files (including logs of what flags have been set, which errors/warnings have occurred, what resources have been utilized, etc.). Note that these exemplary control files are for illustrative purposes only, and are not to be construed as limiting which or what type of control files may be part of control files 112.

Referring now to FIG. 1C, an exemplary Graphical User Interface (GUI) 114, used to present to a software developer the different applications 104 that are running on production computer 102, is illustrated. As depicted, a software developer has selected “Application 104b” to be emulated in the non-production environment of non-production computer 106. Making this selection causes the generation of a second GUI 116, shown in FIG. 1D, which allows the software developer to select specific data files (“Data file 104b-2” and “Data file 104b-3”) and control files (“Control file 104b-1” and “Control file 104b-2”) that are associated with “Application 104b.” Alternatively, specific software objects (not shown), which are part of the application's instructions file, may also be selected to provide a finer granularity of testing of application 104b.

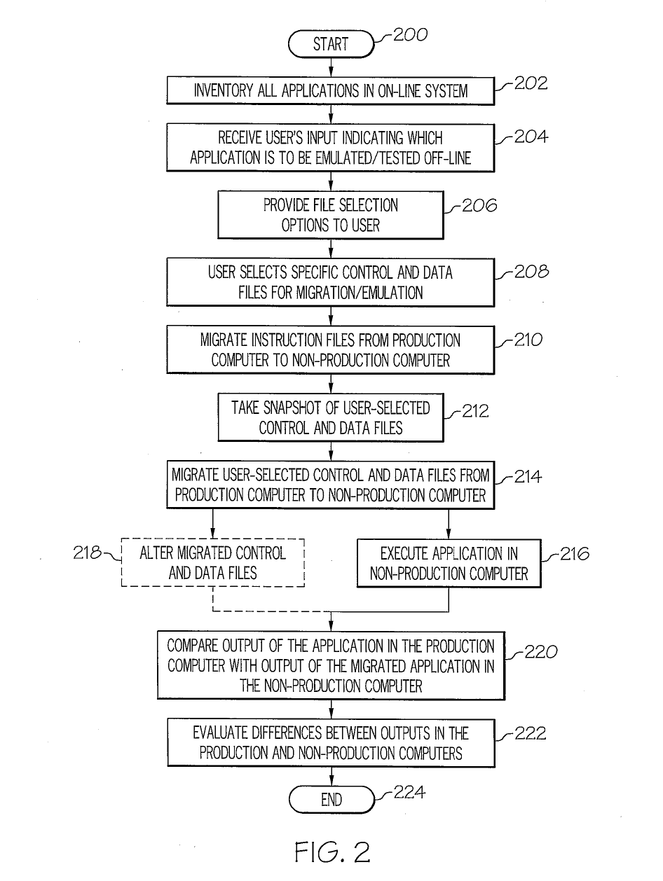

Referring now to FIG. 2, a flow-chart of exemplary steps taken in the present invention is presented. After initiator block 200 (as prompted, for example, by a decision by a software developer to emulate and test an application off-line), an inventory of all applications running on a production computer system is performed (block 202). A listing of these applications is presented to a user, who then selects an application to be emulated for off-line testing in a non-production computer system (block 204). Once a specific application is selected by the user, a listing of data and control files, which are utilized by the selected application, is presented to the user (block 206), who then selects specific control and data files for migration to (and emulation in) the non-production computer system (block 208). Note that an application may have a large number of control and data files, of which only a few are of interest to the user for test purposes. Thus, only a small portion of the control and data files are likely to be selected by the user.

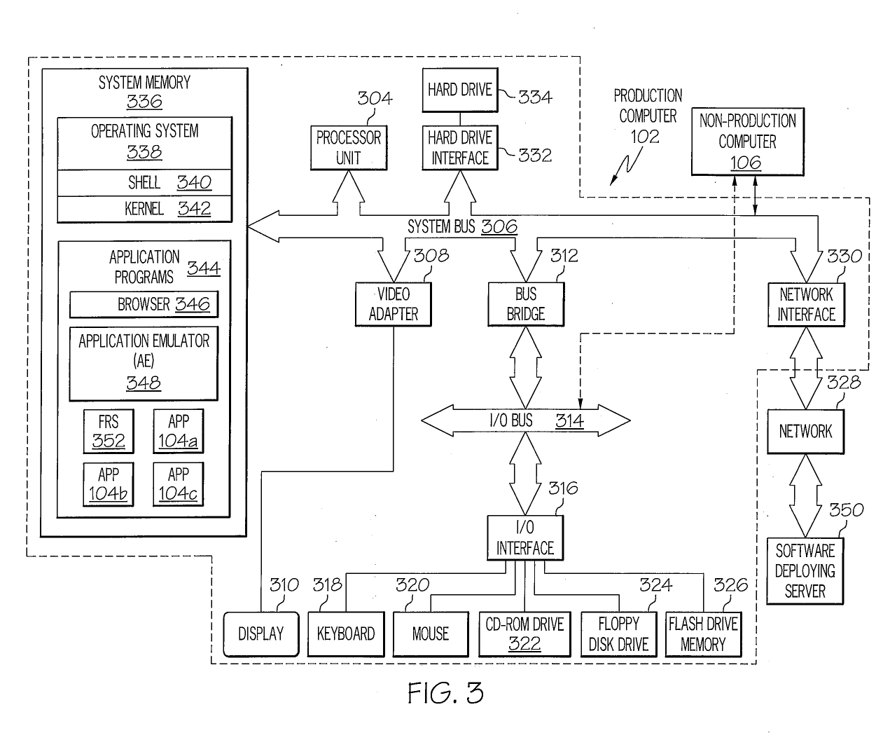

Instruction files for the selected application are first migrated from the production computer system to the non-production computer system (block 210). (Note that in an alternate embodiment, only certain portions of the instructions file 108 are migrated to the non-production computer 106 for emulation.) A snapshot of the user-selected control and data files is then taken, through the use of a fast replication service (block 212), such as FRS 352 shown in FIG. 3, thus providing an accurate time-stamped copy of the selected control and data files at the time of the application migration. Thereafter, the selected control and data files are migrated from the production computer system to the non-production computer system (block 214). By first migrating the instruction files (which are not time-sensitive), then the time-sensitive control and data files (which need to reflect a specific state at a specific time) can be more efficiently and quickly captured and migrated.

As indicated in block 216, the migrated application (including the migrated instructions file, selected data files, and selected control files) is executed in the non-production computer. Note that, in a preferred embodiment, the original version of the application is allowed to continue to execute unfettered in the production computer system while the copied application is executing in the non-production computer system.

Optionally, as illustrated in block 218, the migrated control and data files in the non-production computer system can be altered, thus providing a means for testing the selected application in the non-production environment while using different control and data files.

As depicted in block 220, the output of the application in the production computer system can be compared with the output of the copy of the application in the non-production computer system, whether the control and data files are altered or not. This output may be output to an IO register, a change to control and/or data files, or any other captured output, including fine grain data captures from a scan chain.

Regardless of whether the control and data files have been altered, the differences in the output of the original application and the copied application can then be evaluated, in order to determine what faults may lie in the original unaltered application and/or the migrated altered application (block 222), thus ending the process (terminator block 224).

With reference now to FIG. 3, there is depicted a block diagram of an exemplary production computer 102, in which the present invention may be utilized. Production computer 102 includes a processor unit 304 that is coupled to a system bus 306. A video adapter 308, which drives/supports a display 310, is also coupled to system bus 306. System bus 306 is coupled via a bus bridge 312 to an Input/Output (I/O) bus 314. An I/O interface 316 is coupled to I/O bus 314. I/O interface 316 affords communication with various I/O devices, including a keyboard 318, a mouse 320, a Compact Disk-Read Only Memory (CD-ROM) drive 322, a floppy disk drive 324, and a flash drive memory 326. The format of the ports connected to I/0 interface 316 may be any known to those skilled in the art of computer architecture, including but not limited to Universal Serial Bus (USB) ports.

Production computer 102 is able to communicate with a software deploying server 350 via a network 328 using a network interface 330, which is coupled to system bus 306. Network 328 may be an external network such as the Internet, or an internal network such as an Ethernet or a Virtual Private Network (VPN).

A hard drive interface 332 is also coupled to system bus 306. Hard drive interface 332 interfaces with a hard drive 334. In a preferred embodiment, hard drive 334 populates a system memory 336, which is also coupled to system bus 306. System memory is defined as a lowest level of volatile memory in production computer 102. This volatile memory includes additional higher levels of volatile memory (not shown), including, but not limited to, cache memory, registers and buffers. Data that populates system memory 336 includes production computer 102's operating system (OS) 338 and application programs 344.

OS 338 includes a shell 340, for providing transparent user access to resources such as application programs 344. Generally, shell 340 is a program that provides an interpreter and an interface between the user and the operating system. More specifically, shell 340 executes commands that are entered into a command line user interface or from a file. Thus, shell 340 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 342) for processing. Note that while shell 340 is a text-based, line-oriented user interface, the present invention will equally well support other user interface modes, such as graphical, voice, gestural, etc.

As depicted, OS 338 also includes kernel 342, which includes lower levels of functionality for OS 338, including providing essential services required by other parts of OS 338 and application programs 344, including memory management, process and task management, disk management, and mouse and keyboard management.

Application programs 344 include a browser 346. Browser 346 includes program modules and instructions enabling a World Wide Web (WWW) client (i.e., production computer 102) to send and receive network messages to the Internet using HyperText Transfer Protocol (HTTP) messaging, thus enabling communication with software deploying server 350.

Application programs 344 also include applications 104a-c, described above.

Application programs 344 in production computer 102's system memory (as well as software deploying server 350's system memory) also include an Application Emulator (AE) 348. EA 348 includes code for implementing the processes described in FIG. 1A-2. In one embodiment, production computer 102 is able to download EA 348 from software deploying server 350.

The hardware elements depicted in production computer 102 are not intended to be exhaustive, but rather are representative to highlight essential components required by the present invention. For instance, production computer 102 may include alternate memory storage devices such as magnetic cassettes, Digital Versatile Disks (DVDs), Bernoulli cartridges, and the like. These and other variations are intended to be within the spirit and scope of the present invention. Note that non-production computer 106 may utilize a same or substantially similar architecture as that depicted for production computer 102. Similarly, software deploying server 350 may utilize a same or substantially similar architecture as that depicted for production computer 102.

Note that, in a preferred embodiment of the present invention, software deploying server 350 performs all of the functions associated with the present invention (including execution of EA 348), thus freeing production computer 102 from having to use its own internal computing resources to execute EA 348.

Non-production computer 106 may be coupled to system bus 306, in order to facilitate the operation of a Fast Replication Service (FRS) 352 by directly tapping into system bus 306 to access the application programs 104. Alternatively, non-production computer 106 can be coupled to 10 bus 314, either directly or via 10 interface 316, to access the application programs 104.

It should be understood that at least some aspects of the present invention may alternatively be implemented in a computer-readable medium that contains a program product. Programs defining functions on the present invention can be delivered to a data storage system or a computer system via a variety of tangible signal-bearing media, which include, without limitation, non-writable storage media (e.g., CD-ROM), writable storage media (e.g., hard disk drive, read/write CD ROM, optical media), as well as non-tangible communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

The present invention thus provides for a method, system, and computer-readable medium for emulating an application in a non-production computer system. In a preferred embodiment, the method includes the steps of: receiving a first input that selects an application from all applications on a production computer system; receiving a second input that selects specific control files and data files that are to be utilized in an emulated version of a selected application on a non-production computer system; migrating a copy of instructions file from the selected application from the production computer system to the non-production computer system; subsequently migrating a copy of the specific control files and data files from the production computer system to the non-production computer system; and executing the copy of instructions files, while using the copy of the specific control files and data files, in the non-production computer system. The method may further include the step of taking a snapshot of the specific control files and data files when a copy of the specific control files and data files are migrated to the non-production computer system; synchronizing execution of the application in the production computer system with execution of the copy of the application in the non-production computer system; and upon the application and the copy of the application completing execution of same instructions, comparing a first output from the application in the production computer system with a second output from the copy of the application in the non-production computer system.

In another embodiment, the method further includes the steps of evaluating differences between the first output from the application in the production computer system and the second output from the copy of the application in the non-production computer system, wherein the evaluating provides information regarding faults in the selected application.

In another embodiment, the method includes the steps of altering the copy of the specific control files and data files before executing the copy of the instructions file in the non-production computer system; and evaluating differences between the specific control files and data files and their altered copies in the non-production computer system, wherein the evaluating provides information regarding faults caused by altered copies of the specific control files and data files.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method for emulating an application in a non-production computer system, the method comprising:
receiving a first input that selects an application from all applications on a production computer system;
receiving a second input that selects specific control files and data files that are to be utilized in an emulated version of a selected application on a non-production computer system;
migrating a copy of instructions file from the selected application from the production computer system to the non-production computer system;
subsequently migrating a copy of the specific control files and data files from the production computer system to the non-production computer system; and
executing the copy of instructions files, while using the copy of the specific control files and data files, in the non-production computer system.

2. The method of claim 1, further comprising:
taking a snapshot of the specific control files and data files when a copy of the specific control files and data files are migrated to the non-production computer system.

3. The method of claim 2, further comprising:
synchronizing execution of the application in the production computer system with execution of the copy of the application in the non-production computer system; and
upon the application and the copy of the application completing execution of same instructions, comparing a first output from the application in the production computer system with a second output from the copy of the application in the non-production computer system.

4. The method of claim 3, further comprising:
evaluating differences between the specific control files and data files and their copies in the non-production computer system, wherein the evaluating provides information regarding faults in the selected application.

5. The method of claim 1, further comprising:
altering the copy of the specific control files and data files before executing the copy of the instructions file in the non-production computer system.

6. The method of claim 5, further comprising:
evaluating differences between the first output from the application in the production computer system and the second output from the copy of the application in the non-production computer system, wherein the evaluating provides information regarding faults in the selected application

7. A system comprising:
a processor;
a data bus coupled to the processor;
a memory coupled to the data bus; and
a computer-usable medium embodying computer program code, the computer program code comprising instructions executable by the processor and configured for:
receiving a first input that selects an application from all applications on a production computer system;
receiving a second input that selects specific control files and data files that are to be utilized in an emulated version of a selected application on a non-production computer system;
migrating a copy of instructions file from the selected application from the production computer system to the non-production computer system;
subsequently migrating a copy of the specific control files and data files from the production computer system to the non-production computer system; and
executing the copy of instructions files, while using the copy of the specific control files and data files, in the non-production computer system.

8. The system of claim 7, wherein the instructions are further configured for:
taking a snapshot of the specific control files and data files when a copy of the specific control files and data files are migrated to the non-production computer system.

9. The system of claim 8, wherein the instructions are further configured for:
synchronizing execution of the application in the production computer system with execution of the copy of the application in the non-production computer system; and
upon the application and the copy of the application completing execution of same instructions, comparing a first output from the application in the production computer system with a second output from the copy of the application in the non-production computer system.

10. The system of claim 9, wherein the instructions are further configured for:
evaluating differences between the specific control files and data files and their copies in the non-production computer system, wherein the evaluating provides information regarding faults in the selected application.

11. The system of claim 8, wherein the instructions are further configured for:
altering the copy of the specific control files and data files before executing the copy of the instructions file in the non-production computer system.

12. The system of claim 11, wherein the instructions are further configured for:
evaluating differences between the first output from the application in the production computer system and the second output from the copy of the application in the non-production computer system, wherein the evaluating provides information regarding faults in the selected application.

13. A computer-readable medium embodying computer program code for emulating an application in a non-production computer system, the computer program code comprising computer executable instructions configured for:
receiving a first input that selects an application from all applications on a production computer system;
receiving a second input that selects specific control files and data files that are to be utilized in an emulated version of a selected application on a non-production computer system;
migrating a copy of instructions file from the selected application from the production computer system to the non-production computer system;
subsequently migrating a copy of the specific control files and data files from the production computer system to the non-production computer system; and
executing the copy of instructions files, while using the copy of the specific control files and data files, in the non-production computer system.

14. The computer-readable medium of claim 13, wherein the computer executable instructions are further configured for:
taking a snapshot of the specific control files and data files when a copy of the specific control files and data files are migrated to the non-production computer system.

15. The computer-readable medium of claim 14, wherein the computer executable instructions are further configured for:
synchronizing execution of the application in the production computer system with execution of the copy of the application in the non-production computer system; and
upon the application and the copy of the application completing execution of same instructions, comparing a first output from the application in the production computer system with a second output from the copy of the application in the non-production computer system.

16. The computer-readable medium of claim 15, wherein the computer executable instructions are further configured for:
evaluating differences between the specific control files and data files and their copies in the non-production computer system, wherein the evaluating provides information regarding faults in the selected application.

17. The computer-readable medium of claim 13, wherein the computer executable instructions are further configured for:
altering the copy of the specific control files and data files before executing the copy of the instructions file in the non-production computer system.

18. The computer-readable medium of claim 17, wherein the computer executable instructions are further configured for:
evaluating differences between the first output from the application in the production computer system and the second output from the copy of the application in the non-production computer system, wherein the evaluating provides information regarding faults in the selected application.

19. The computer-readable medium of claim 13, wherein the computer-usable medium is a component of a remote server, and wherein the computer executable instructions are deployable to a production computer from the remote server.

20. The computer-readable medium of claim 13, wherein the computer executable instructions are capable of being provided by a service provider to a customer on an on-demand basis.
